(19) United States
(12) Patent Application Publication
(10) Pub. No.: US 2007/0043456 A1
(43) Pub. Date: Feb. 22, 2007

(54) Electronic device and method of representing an application or data using a shell application

(76) Inventor: William Allan Clark, Leyton (GB)

Correspondence Address: MOTOROLA INC, 600 NORTH US HIGHWAY 45, ROOM AS437, LIBERTYVILLE, IL, 60048-5343, US

(21) Appl. No.: 10/574,239

(22) PCT Filed: Oct. 1, 2004
(86) PCT No.: PCT/EP04/52409

§ 371 Date: Mar. 30, 2006

(30) Foreign Application Priority Data
Oct. 3, 2003 (GB) 0323143.8

(51) Int. Cl. G05B 11/01; G05B 15/00

(52) U.S. Cl. 700/83; 700/17

(57) ABSTRACT

An electronic device (200) comprises a user interface (210) and a memory element (216), operably coupled to the user interface (210), which stores one or more files (applications or items of data) to be represented on the user interface. A processor (208) is operably coupled to the user interface (210) and memory element (216), and comprises a shell application (209) for representing the one or more files (217) on the user interface (210). The shell application (209) runs the executable code related to the one or more files (217) to provide to the user interface a representation of the one or more files (217) determined by the executable code. In this manner, a more useful and intuitive user interface is achieved as the shell representation of an application is able to provide a dynamic and context sensitive representation of itself.

### FIELD OF THE INVENTION

The present invention relates to an electronic device with a user interface. The invention is applicable to, but not limited to, a shell application used to represent one or more applications via the user interface.

### BACKGROUND OF THE INVENTION

Many modern day electronic products have some form of user interface. In particular, in computing and communication devices, the user interface is often a ‘display’ that is typically configured to present a large and varied amount of information to a user of the device. The ‘shell’ of a computer-based user interface (UI) is the primary interface between the computer and the user.

In the context of a user interface, it is known that “shell” applications are used to provide information to the user of, say, a computer device by displaying representations of the applications and data stored within the device. Thus, the activating and viewing of a particular representation of data stored within the device is performed by a shell application. A shell application also provides the functionality to pass parameters to a starting program.

Over time, the shell of a computer has moved on from batch processing of punch cards through magnetic cards and teletypes. An example of a known user interface (UI) is a “character mode” cathode ray tube (CRT) display, where the CRT only displays characters in columns and rows. In this case, a simple Shell application program (input interface) may provide an “ls” instruction, which would provide a listing of directories and files. Here, the representation is of the simple listing of the filename (displayed by shell) using, say, a 25-row by 80-column text layout, where each cell (comprising 1-row and 1-column) is a character.

A later example of a UI is a bitmap display, where instead of a display cell being limited to a simple character, there is no restriction other than any display item is made up of more than one dot or “pixel”. A simple character is then composed of, say, a ‘10’×‘12’ matrix of pixels. Hence, graphical representations can be handled by the Shell application inasmuch as the shell application is able to draw/assign any graphical representation to any type of file.

Existing shells of modern day computers are the “desktops” or the “finder” of personal computer (PC) operating systems. Notably, all o:E these shells display ‘static’ representations of the data that exist on the device.

FIG. 1 discloses a flowchart 100 of a known mechanism for a shell application to represent data on a computer's UI. First, a display is activated in step 105. A shell application then scans one or more directories and/or files that is/are available within the device to be displayed to a user, as shown in step 110. Thus, the shell application knows where to look for the data to be displayed. A popular current shell application is a Graphical User Interface (GUI). The shell application itself then determines factors on how to represent the data, for example which icon or caption to use, what colour and/or size to be used for the icon/caption, etc., as shown in step 115. The shell application then picks up the selected icon and/or caption relating to an item of data and displays the selected icon and/or caption, as shown in step 120. Thus, in all known scenarios, the displayed representation is determined by the shell application, as shown in step 125.

It is known that the shell application may extend a basic icon or caption by applying an animation effect to the ‘static’ data provided, such as a sequence of bitmaps, or display a URL in a particular manner. Animation is a well known method of creating illusion of movement by a rapid sequencing of still images, i.e. ‘static’ data. Nevertheless, it is noted that it is still the shell application that determines how to display the ‘static’ data.

Thus, in all of the known scenarios, the data forwarded to a UI for displaying is wholly dictated by the shell application. For example, in the common desktop ‘Windowing’ shell application of contemporary computer systems, the shell application itself determines and displays representations of files.

The inventor of the present invention has recognised and appreciated that the aforementioned shell application technique is particularly restrictive. A need has therefore arisen for an improved shell application and mechanism for representing data in a UI, wherein the abovementioned disadvantages may be alleviated.

Statement of Invention

In accordance with a first aspect of the present invention, there is provided an electronic device. The electronic device comprises a user interface and a memory element, operably coupled to the user interface, which stores one or more files (e.g. applications or items of data) to be represented on the user interface. A processor is operably coupled to the user interface and the memory element and comprises a shell application for representing the one or more files on the user interface. Notably, the one or more files is/are configured with an executable code, such that the shell application runs the executable code of the one or more files to provide to the user interface a representation of the one or more files.

Thus, the present invention provides an electronic device with an improved user interface, shell application and mechanism for representing one or more files, whereby an application that wished to provide a richer representation of itself, or a context sensitive representation, is configured to provide executable code for the shell application to run.

In this manner, it is the one or more files themselves that dictate how the one or more files is/are to be represented, and not the application shell.

In accordance with a second aspect of the present invention, there is provided a method of representing one or more applications on an electronic device. The method of representing one or more files (applications and/or data items) on an electronic device comprises the steps of activating a user interface, such as a display and scanning, by a shell application, one or more directories and/or files that is/are available within the electronic device to be represented to a user. The method further comprises the steps of identifying, by the shell application, code for files and/or aspects of files that can be executed; executing, by the shell application, the identified executable code; and representing the executable code on the user interface.

In accordance with a third aspect of the present invention, there is provided a storage medium storing processor-implementable instructions for controlling one or more processors, as claimed in claim 12 and claim 13.

Preferably, the executable code of the one or more files comprises multiple respective representations of the one or more applications or items of data either by plug-ins or within the software code of the application or item of data itself. In this regard, a user may be provided with the ability to control the representations within the electronic device's UI.

Furthermore, the shell application preferably exports an application programming interface for use by the one or more files. In this manner, the one or more files may be able to provide a wide range of representations on the user interface, so long as the one or more files comply with the application programming interface.

In addition, the shell application preferably represents the one or more files dependent upon a file type and/or an additional file associated with the one or more files. This provides greater flexibility for the one or more files in identifying the executable code to be selected by the shell application.

Further aspects and advantageous features of the present invention are as described in the appended Claims.

### BRIEF DESCRIPTION OF THE DRAWINGS

FIG. 1 illustrates a flowchart of a known process for representing applications, such as that used in Windows Explorer where icons can be displayed as a detailed or basic list;

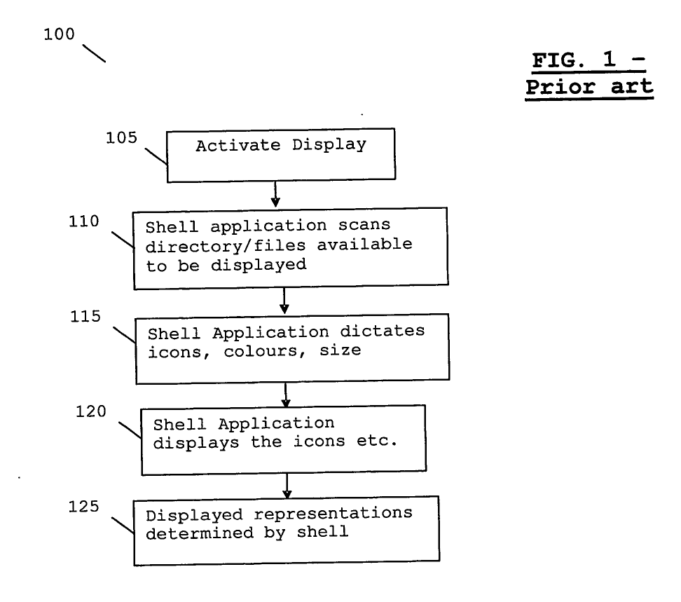

Exemplary embodiments of the present invention will now be described, by way of example only, with reference to the accompanying drawings, in which:

FIG. 2 illustrates a block diagram of a wireless communication unit, adapted to support the inventive concepts of the preferred embodiments of the present invention; and

FIG. 3 illustrates a flowchart of a process for representing one or more files (applications or items of data) employed by an electronic device in accordance with the preferred embodiment of the present invention.

### DESCRIPTION OF PREFERRED EMBODIMENTS

The preferred embodiment of the present invention is described with reference to a ‘living shell’ user interface for applications and data stored on an electronic device such as a computer or processor-based device or communication device such as a portable cellular phone capable of operating on current or future generation wireless cellular technology. However, it is within the contemplation of the present invention that the inventive concepts described herein are equally applicable to any user interface of an electronic device such as a personal data assistant (PDA), a portable or mobile radio, a PSTN phone, etc.

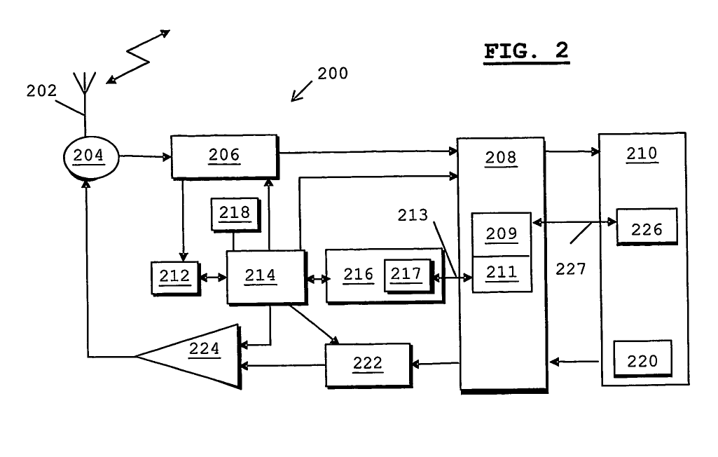

The preferred embodiment of the present invention is described with reference to a wireless communication unit such as a mobile phone. Referring now to FIG. 2, there is shown a block diagram of part of a wireless communication unit 200 adapted to support the inventive concepts of the preferred embodiments of the present invention. The wireless communication unit 200 contains an antenna 202 preferably coupled to a duplex filter or antenna switch 204 that provides isolation between receive and transmit chains within the communication unit 200. The receiver chain, as known in the art, includes receiver front-end circuitry 206 (effectively providing reception, filtering and intermediate or base-band frequency conversion). The front-end circuit is serially coupled to a signal processing function 208. An output from the signal processing function 208 is operably coupled to a user interface 210 via an interaction medium 227. The user interface comprises one or more output devices, such as a screen or flat panel display or loudspeaker 226 and one or more input devices, such as a keypad or keyboard or a microphone 220.

For completeness, the receiver chain also includes received signal strength indicator (RSSI) circuitry 212, which in turn is coupled to a controller 214 for maintaining overall communication unit control. The controller 214 is also coupled to the receiver front-end circuitry 206 and the signal processing function 208 (generally realised by a digital signal processor (DSP)) The controller 214 may therefore receive bit error rate (BER) or frame error rate (FER) data from recovered information. The controller is also coupled to a memory element 216 that stores operating regimes, such as decoding/encoding functions, data, application code and the like. The memory element 216 is operably coupled to a shell application 209 in the signal processor function 208 via a communication medium 213. A timer 218 is typically coupled to the controller 214 to control the timing of operations (transmission or reception of time-dependent signals) within the communication unit 200.

As regards the transmit chain, this essentially includes the user interface 210 being operably coupled in series through transmitter/modulation circuitry 222 and a power amplifier 224 to the antenna 202. The transmitter/modulation circuitry 222 and the power amplifier 224 are operationally responsive to the controller 214.

In accordance with the preferred embodiment of the present invention, the shell 209 exposes an application programming interface (API) 211. Notably, the API 211 provides the mechanism for an executable representation of the one or more application(s) and/or data 217 stored in memory element 216 to be provided to the shell application 209. The API 211 also provides the mechanism for use with executable code relating to document types that are associated with the one or more application(s) and/or data 217 to be provided to the shell application 209.

For the remaining description, executable applications or data items will be referred to as ‘files’, where the shell application 209 sees one or more files (one or more applications or items of data) and determines whether the file(s) is/are ‘executable’ based on attributes in the file name, i.e. read/write/executable/etc. Note that applications may comprise multiple files.

Thus, in contrast to the known mechanism of providing the shell application access to static data elements that enable the shell to represent only the file that corresponds to the static data, each file 217 in memory element 216 provides access to an executable representation of itself or associated document type that conforms to the programming interface expected by the shell application 209. The shell application 209 then executes the executable component. Thus, the shell application 209 is able to display a rich and context sensitive representation of the file(s) (application(s) or items of data) 217 on the output device 226. Advantageously, the representation is determined by the file(s) 217, rather than by the shell application 209. In this manner, the functionality of an application is extended and yet contained in a well-defined manner.

The shell application 209 of the preferred embodiment of the present invention preferably scans a data and/or application directory within the memory element 216. However, in accordance with the preferred embodiment of the present invention, the shell application 209 is configured to “execute” the codes that it finds within the data and/or application directory, i.e. the applications themselves dictate how features of those applications are to be represented to the user via the shell application 209. In this manner, the representation is independent of the shell application 209. The shell application 209 follows the commands of the executable codes and displays what it is informed, in a form that is dictated by the executable code and not by the shell application 209.

Preferably, the API 211 operates in accordance with an agreed explicit or implicit contract between the application developers and the shell application 209. In this regard, the shell application 209 will be able to support, say, the desired size of display depth, number of colours, etc., set by the executable code of the application.

Thus, the preferred embodiment of the present invention provides a transfer of representation control from the shell application 209 to the applications themselves, in how the shell application 209 represents a computer's or communication device's application(s) and/or data on a user interface 226.

More generally, according to the preferred embodiment of the present invention, an application and/or a shell application may be re-programmed in a respective device, such as a computer or communication device, in any suitable manner to effect an improved user interface mechanism. For example, a new memory element or signal processor may be added to an electronic device.

Alternatively, existing parts of an electronic device such as a wireless communication unit 200 may be adapted, for example by reprogramming one or more signal processors 208, or uploading data to a memory element 216, therein. As such, the required adaptation may be implemented in the form of processor-implementable instructions stored on a storage medium, such as a floppy disk, hard disk, programmable read only memory (PROM), random access memory (RAM) or any combination of these or other storage media.

With the emergence of ‘plug-in’ technology as a mechanism to introduce software temporarily into an electronic device such as a mobile phone, it is envisaged that ‘plug-in’ applications are particularly suited to use the aforementioned inventive concepts. As such, it is envisaged that multiple ‘desktops’ and screens can be supported by using ‘plug-in’ applications/files having different forms of executable code. Thus, it is envisaged that an application may be provided via multiple plug-ins, in order to support multiple representation styles.

In the context of the present invention, the expression ‘plug-in’ encompasses any special purpose “helper application”, such as a small software program that helps a Web browser interpret certain types of media files. In this regard, a ‘plug-in’ is a seperate executable that is used to support a primary application; in this case to represent a file to the shell application program of the electronic device.

In an enhanced embodiment of the present invention, it is envisaged that an application may comprise multiple executable codes, one or more of which is accessible by the shell application. Thus, if the user is able to select from the multiple executable codes, it is possible for a user to fully customise his/her UI interface (or ‘desktop’ in the computing domain), dependent upon the context and means provided to represent the application. For example, by selecting executable code for one or more applications from a number of executable codes, a user is able to customise the UI to enable easy access to key applications, such as email, web-access, telephone contacts, messaging, etc.

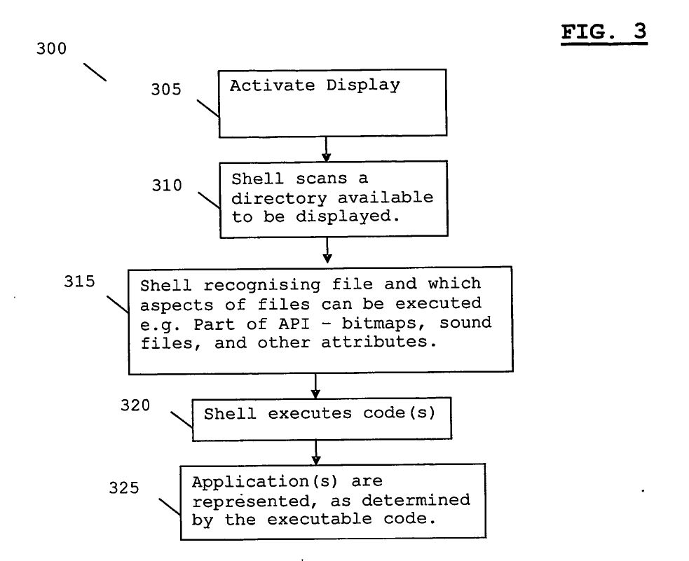

Referring now to FIG. 3, a flowchart 300 illustrates a mechanism for a shell application to represent data on an electronic device's UI in accordance with a preferred embodiment of the present invention. First, a display is activated in step 305. A shell application then scans one or more directories and/or files that is/are available within the electronic device and that are identifiable as being able to be displayed to a user, as shown in step 310. As in the known technique, it is envisaged that the shell application will know where to look for the applications and/or data that relate to an application that is to be displayed.

The shell application then recognises files and aspects of files that can be executed, for example a part of an API bitmap, sound files, other attributes, etc., as shown in step 315. Notably, the shell application then executes the identified executable code, as shown in step 320. The executable code configures the representation to be displayed, which is determined by the application and/or data itself rather than the shell application, as shown in step 325.

Thus, it is within the contemplation of the present invention that the inventive concepts described herein are applicable to any interface of an electronic device, such as a computer or mobile phone interface, which uses a graphical display to represent files and/or applications stored therein.

It will be understood that the improved user interface mechanism, as described above, aims to provide at least one or more of the following advantages:
(i) A more useful and intuitive user interface is supported by one or more files (applications and/or data items) having executable code(s), as the representation of an application is able to provide a dynamic and context sensitive representation of itself.
(ii) Extends the functionality of an application in a way that can be contained in a well-defined and contained manner.
(iii) It provides a mechanism to fully customise a UI.
(iv) If multiple forms of an application's executable code are provided, either by plug-ins or within the software code of the application itself, a user is able to control the electronic device's UI.
(v) It provides the ability to execute shell applications within an interactive medium, by causing the transfer of representation control to the applications themselves.

Whilst the specific and preferred implementations of the embodiments of the present invention are described above, it is clear that one skilled in the art could readily apply variations and modifications of such inventive concepts.

Thus, an electronic device and an improved user interface mechanism have been described where the aforementioned disadvantages with prior art arrangements have been substantially alleviated.

1. An electronic device (200) comprising:
a user interface (210);
a memory element (216), operably coupled to the user interface (210), which stores one or more files (217) to be represented on the user interface;
a processor (208), operably coupled to the user interface (210) and memory element (216), wherein the processor (208) comprises a shell application (209) for representing the one or more files (217) on the user interface (210); the electronic device (200) characterised in that:
the one or more files (217) is/are configured with an executable code, such that the shell application (209) runs the executable code of the one or more files (217) to provide to the user interface a representation of the one or more files (217).

2. An electronic device (200) according to claim 1, wherein the executable code of the one or more files (217) comprises multiple respective representations of the one or more files (217).

3. An electronic device (200) according to claim 1, wherein the shell application (209) searches the memory element (216) for the one or more files (217) containing executable code.

4. An electronic device (200) according to claim 1, wherein the shell application (209) exports an application programming interface (211) for use by the one or more files (217).

5. An electronic device (200) according to claim 4, wherein the application programming interface (211) supports a set of user interface features of the one or more files (217), for example an indication of one or more of the following: an area and/or size of a display, a number of colours to be used in a representation, a type of display to be used.

6. An electronic device (200) according to claim 4, wherein the shell application represents the one or more files (217), dependent upon a file type and/or an additional associated file.

7. An electronic device (200) according to claim 4, wherein the file type or additional files that can be executed comprise one or more of the following: a part or a whole of an application protocol interface bitmap, one or more sound files, an attribute or feature of a display.

8. An electronic device (200) according to claim 1, wherein the user interface is a display, such that the shell application represents the one or more files (217) running on the electronic device as, say, an icon of the application.

9. An electronic device (200) according to claim 1, wherein the electronic device (200) is one of: a cellular phone, a personal data assistant (PDA), a portable or mobile radio, a laptop computer or a wirelessly networked personal computer (PC).

10. A method of representing one or more applications on an electronic device comprising the steps of:
activating (305) a user interface, such as a display;
scanning (310), by a shell application, one or more directories and/or files that is/are available within the electronic device to be represented to a user; wherein the method is characterised by the steps of:
identifying (315), by the shell application, code for files and/or aspects of files that can be executed;
executing (320), by the shell application, the identified executable code; and
representing (325) the executable code on the user interface.

11. A method of representing one or more applications on an electronic device according to claim 10, wherein the identified executable code relates to one or more applications or items of data of the electronic device to be represented, such that the executable code of the one or more applications or items of data determines how the one or more applications or items of data are to be represented.

12. A storage medium storing processor-implementable instructions for controlling one or more processors in the electronic device according to claim 1.

13. A storage medium storing processor-implementable instructions for controlling one or more processors for performing the steps of claim 10.
